(19) United States
(12) Patent Application Publication
(10) Pub. No.: US 2019/0354838 A1
(43) Pub. Date: Nov. 21, 2019

(54) Automobile Accident Detection Using Machine Learned Model

(71) Applicant: Uber Technologies, Inc., San Francisco, CA (US)

(72) Inventors: Yanwei Zhang, Foster City, CA (US); Karim A. Wahba, San Francisco, CA (US); Nikolaus Paul Volk, San Francisco, CA (US); Gorkem Ozkaya, San Francisco, CA (US)

(21) Appl. No.: 16/417,381

(22) Filed: May 20, 2019

Related U.S. Application Data
(60) Provisional application No. 62/750,164, filed on Oct. 24, 2018.
(60) Provisional application No. 62/674,605, filed on May 21, 2018.

(51) Int. Cl. G06N 3/04; G07C 5/08; G07C 5/00; G06N 3/08

(52) U.S. Cl. CPC G06N 3/0445; G06N 3/08; G07C 5/008; G07C 5/085

(57) ABSTRACT

A system detects whether an automobile was involved in an accident. The system receives sensor data detecting motion of the automobile, for example, acceleration or location of the automobile. The system aggregates features describing the impact event including contextual features, for example, type of roadway, speed limit, and points of interest near the location of impact and event features, for example, force of impact, distance travelled since impact, speed before the impact, and so on. The system provides the features as input to a machine-learned model. The system determines using the machine-learned model whether the automobile was involved in an accident. The system may provide sensor data describing the impact to a neural network to generate feature vectors describing the sensor data. The system uses the feature vector for determining whether an impact occurred.

### BACKGROUND

### Technical Field

The subject matter generally relates detecting automobile accidents using a machine-learned model based on data collected by a mobile device or sensors located within the automobile and contextual data regarding a potential accident.

### Background Information

Current methods for automatically detecting automobile accidents rely on user inputs or sensor data. For example, a high g-force registered by a mobile device may trigger an accident alert, to be confirmed by a human. However, using sensor data alone leads to errors. For example, the mobile device located within the automobile may register a high g-force after sudden braking, after being dropped out of a user's hands or off of a seat, or after other non-accident events. Because of the risk of false positives, the mobile device may request input from a user to confirm that an accident occurred and, after receiving confirmation, request assistance. However, after a serious crash, the user may be unable to provide a response, thus delaying assistance to the user.

### SUMMARY

Embodiments detect whether an automobile was involved in an accident. An impact event having a specific force greater than a threshold force is detected based on a signal related to an acceleration measurement. The movement of the mobile device is determined to have been stopped for at least a threshold duration following the impact event based on a signal related to a location measurement. The acceleration measurement and/or location measurement may be performed by a mobile device located within the automobile or by other sensors, for example, sensors of the automobile. A plurality of event features describing the impact event and a plurality of contextual features describing the context of the impact event are aggregated. The event features comprise features generated based on data output by sensors of the mobile device within a threshold time period that includes a time of the impact event. The contextual features comprise features generated based on data describing a ride during which the impact event occurred. A machine-learned model trained to detect automobile accidents based on event features and contextual features is used to determine that an automobile accident has occurred. Responsive to determining that the automobile accident has occurred, information describing the automobile accident is sent via a message, for example, a message to a user who can take appropriate action to provide assistance to the people in the automobile that was involved in an accident. Examples of such user include the rider, the driver, an operator associated the ride providing service, any authorities, or designated contacts of the rider or driver.

Examples of event features include a measure of force of the impact, distance traveled since the impact, a measure of speed during a time period before the impact, and a measure of deceleration in the time period before the impact. Examples of contextual features include a distance between a location of the vehicle at the time of impact and a destination of the ride, a distance between the location of the vehicle at the time of impact and the location of the starting point of the ride, a difference between an estimated time of arrival at the destination and the time of impact, a type of a roadway where the impact occurred, a speed limit of the roadway where the impact occurred, information describing points of interest within a threshold distance of the location of impact, and a measure of frequency of accidents within a threshold distance of the location of impact.

In an embodiment, the mobile device is located within the vehicle. The mobile device sends information describing the ride to a remote system executing on a server outside the vehicle. The remote system executes the machine-learned model.

In an embodiment, the machine-learned model is a first machine-learned model. If the first machine-learned model indicates a high likelihood that an accident has occurred, a second machine-learned model confirms whether an accident has occurred.

In an embodiment, sensor data associated with the ride is provided to a neural network to generate a sensor embedding representing features describing the sensor data. The generated features describing the sensor data are provided as input to the machine machine-learned model.

In an embodiment, the machine-learned model is trained using a training dataset determined using information describing previous rides. The training dataset comprises positive samples representing rides with an accident and negative samples representing rides without an accident.

In some embodiments, feature vectors describing sensor data are generated using neural networks for use in determining whether an automobile was involved in an accident during a ride. Sequences of data collected by sensors during a ride are received. Examples of sensors include an accelerometer, a gyroscope, or a global positioning system receiver. Each sequence of data represents a time series describing a portion of the ride. The portion of the ride comprises a stop event or a drop-off event. A sequence of features is generated from the sequences of data. The sequence of features may be determined by repeatedly evaluating statistics based on sensor data collected for subsequent time intervals within the portion of the ride. Examples of statistics evaluated include a minimum, maximum, mean, standard deviation, and fast Fourier transform (FFT). The sequence of features is provided as input to a neural network. The neural network comprises one or more hidden layers of nodes. A sensor embedding representing output of a hidden layer of the neural network is generated by the hidden layer responsive to providing the sequence of features as input to the neural network. A machine-learned model determines that an automobile accident has occurred based on the extracted sensor embedding. The machine-learned model is trained to detect automobile accidents based on a sensor embedding. Responsive to determining that the automobile accident has occurred, a message comprising information describing the automobile accident is transmitted, for example, to a user to take appropriate action.

In some embodiments, the neural network is a recurrent neural network, for example, a long short term memory (LSTM) neural network.

In an embodiment, the sequence of data is received by detecting a stop event indicating that the automobile stopped or a drop-off event. The data is received from one or more sensors for a time window around the detected event.

In an embodiment, the neural network model is trained using previously recorded training dataset describing rides. The training dataset comprises data describing one or more rides labeled as having an accident based on an accident report.

### BRIEF DESCRIPTION OF THE DRAWINGS

FIG. 1 is a high-level block diagram illustrating a networked computing environment for performing accident detection, according to one embodiment.

FIG. 2 illustrates a process of determining whether an accident has occurred using a machine-learned model, according to one embodiment.

FIG. 3 illustrates a block diagram of a driver app, according to one embodiment.

FIG. 4 illustrates a block diagram of an accident modeling subsystem 160, according to one embodiment.

FIG. 5 is a high-level block diagram illustrating an example of a computer suitable for use in the system environment of FIG. 1, according to one embodiment.

FIG. 6 illustrates a block diagram of a feature learning subsystem, according to one embodiment.

FIG. 7 shows an example recurrent neural network for generating sensor embeddings, in accordance with an embodiment.

The Figures (FIGS.) and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

In addition to sensor data detected at a cellular phone, contextual information is used to more accurately predict whether or not an accident has occurred. For example, if a vehicle stops or brakes suddenly, a driver's (or passenger's) phone may detect a high g-force due to an accident, or due to the phone flying onto the floor of the car. If a phone does not detect movement for a period of time following the high g-force, this could be because of an accident, traffic, or a planned or unplanned stop. A high g-force in combination with a stop, or simply an extended stop, could register to a standard accident detection system as an accident. However, it may be the case that the driver stopped short at a destination (e.g., when a rider called out “stop here!”), causing the driver's phone to hit the floor and register a high g-force. After this, the driver may stop for several minutes while the rider collects belongings and exists the vehicle. As another example, the driver may stop at a gas station along a route, and a standard accident detection system may register this unplanned stop as an accident.

Considering contextual information regarding a potential accident event, such as the location of the event relative to the destination location, or the location of the event relative to points of interest, enables a more accurate assessment of whether or not an accident has in fact occurred. According to an embodiment, a machine-learned model considers a larger set of signals about an event, including information about the context of that event, and provides a highly accurate assessment of whether or not an accident occurred. Based on this accurate assessment, assistance can be provided to the driver and rider immediately. The driver or rider need not confirm that an accident occurred, which is inconvenient if an accident has not occurred, and may be dangerous if an accident has occurred and the driver or rider is in peril.

Although various embodiments are described herein in the context of automobiles, the techniques disclosed herein are applicable to any kind of vehicle, for example, automobiles, trucks, bikes, scooters, aircraft, public transport like trains and buses, autonomous vehicles, and so on. The term automobile accident and vehicle accident is used interchangeably herein.

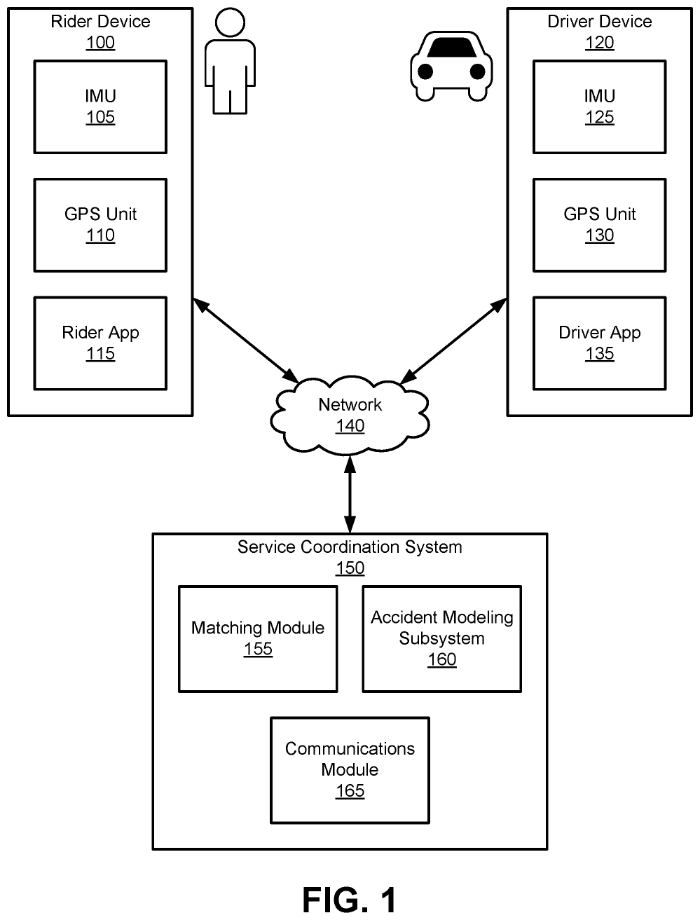

FIG. 1 illustrates one embodiment of a networked computer environment for performing accident detection. The environment includes a rider device 100, a driver device 120, and a service coordination system 150, all connected via a network 140. A rider is any individual other than the driver who is present in the vehicle. Although only one rider device 100 and driver device 120 are shown, in practice many devices (e.g., thousands or even millions) may be connected to the network 140 at any given time. In other embodiments, the networked computing environment contains different and/or additional elements. In addition, the functions may be distributed among the elements in a different manner than described.

The rider device 100 and driver device 120 are computing devices suitable for running applications (apps). The rider device 100 and driver device 120 can be smartphones, desktop computers, laptop computers, PDAs, tablets, or any other such device. In the embodiment shown in FIG. 1, the rider device 100 includes an inertial measurement unit (IMU) 105, a GPS (global positioning system) unit 110 (i.e., a GPS receiver), and a rider app 115.

The IMU 105 is a device for measuring the specific force and angular rate experienced by the rider device 100. The IMU 105 includes sensors such as one or more accelerometers and one or more gyroscopes. The IMU 105 also includes a processing unit for controlling the sensors, processing signals received from the sensors, and providing the output to other elements of the rider device 100, such as the rider app 115.

The GPS unit 110 receives signals from GPS or other positioning satellites and calculates a location based on the received signals. In some embodiments, the GPS unit 110 also receives signals from the IMU 105 to more accurately determine location, e.g., in conditions when GPS signal reception is poor. The GPS unit 110 provides the determined location to other elements of the rider device 110, such as the rider app 115.

The rider app 115 provides a user interface for the user of the rider device 100 (referred to herein as the “rider”) to request a ride from a driver based on the location of the rider device 100 indicated by the GPS unit 110, a destination address, a vehicle type, or one or more other factors. After a driver is matched to the ride request, the rider app 115 receives information about the matched driver. The rider app 115 enables the rider to receive a ride from a driver, e.g., the user of the driver device 120 (referred to herein as the “driver”). In some embodiments, the rider app 115 is also configured to detect an accident while the rider is riding with the driver based on data from the IMU 105, data from the GPS unit 110, and contextual data about the ride. In some embodiments, the rider app 115 is configured to provide data from the IMU 105 and/or the GPS unit 110 to the service coordination system 150.

The driver device 120 includes an IMU 125, which is similar to the IMU 105, and a GPS 130, which is similar to the GPS 130. The driver device 120 also includes a driver app 135, which provides a user interface for the driver to receive a request from the rider app 115 that was matched to the driver. The driver app 135 may receive ride requests within a vicinity of the location determined by the GPS unit 130. The driver app 135 may provide information about the ride to the driver during the ride, such as routing information, traffic information, destination information, etc. In some embodiments, the driver app 135 is also configured to detect an accident while driver is driving based on data from the IMU 125, data from the GPS unit 130, and contextual data about the ride. In some embodiments, the driver app 135 is configured to provide data from the IMU 125 and/or the GPS unit 130 to the service coordination system 150. In some embodiments, the components of the driver device 120 are integrated into an autonomous vehicle that does not have a human driver, and the driver app 135 does not have a human user.

The service coordination system 150 manages a ride providing service in which drivers provide services to riders. The service coordination 150 interacts with the rider app 115 and the driver app 135 to coordinate such services. The service coordination system 150 includes, among other components, a matching module 155, an accident modeling subsystem 160, and a communications module 165.

The matching module 155 matches riders to drivers so that drivers may provide rides to riders. The matching module 155 maintains information about eligible drivers (e.g., current location, type of car, rating, etc.). The matching module 155 receives a request for a ride from a rider app 115 with information such as the type of car desired and the pickup location. The matching module 155 then matches the rider to one of the eligible drivers (e.g., the driver with the driver device 120 shown in FIG. 1), and transmits the request to the driver device 120. The driver app 135 provides relevant information about the requested ride to the driver, who can drive to meet the rider and then drive the rider to his destination.

The accident modeling subsystem 160 learns a model for detecting accidents based on sensor data collected by the rider app 115 and/or the driver app 135, along with contextual information about a ride. The accident modeling subsystem 160 may store the trained accident detection model locally at the service coordination system 150 and use it to detect accidents based on data received from the rider app 115 and/or the driver app 135. In some embodiments, the accident modeling subsystem 160 transmits the trained accident detection model to the rider device 100 and/or the driver device 120, which use the model to detect accidents locally. The accident modeling subsystem 160 is described in greater detail with respect to FIG. 4.

The communications module 165 is configured to communicate with various devices, such as the rider device 100 and the driver device 120, over the network 140. In some embodiments, the communications module 165 is also configured to communicate with outside services, such as an emergency dispatch center, in response to detecting an accident during a ride. For example, the communications module 165 identifies one or more appropriate parties to notify regarding a detected accident (e.g., emergency services in a particular jurisdiction, emergency contacts of the rider and/or the driver, an insurance company, etc.) and automatically transmit a notification about the accident or open lines of communication to the identified parties.

The network 140 provides the communication channels via which the other elements of the networked computing environment shown in FIG. 1 communicate. The network 140 can include any combination of local area and/or wide area networks, using both wired and/or wireless communication systems. In one embodiment, the network 140 uses standard communications technologies and/or protocols. For example, the network 140 can include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, all or some of the communication links of the network 140 may be encrypted using any suitable technique or techniques.

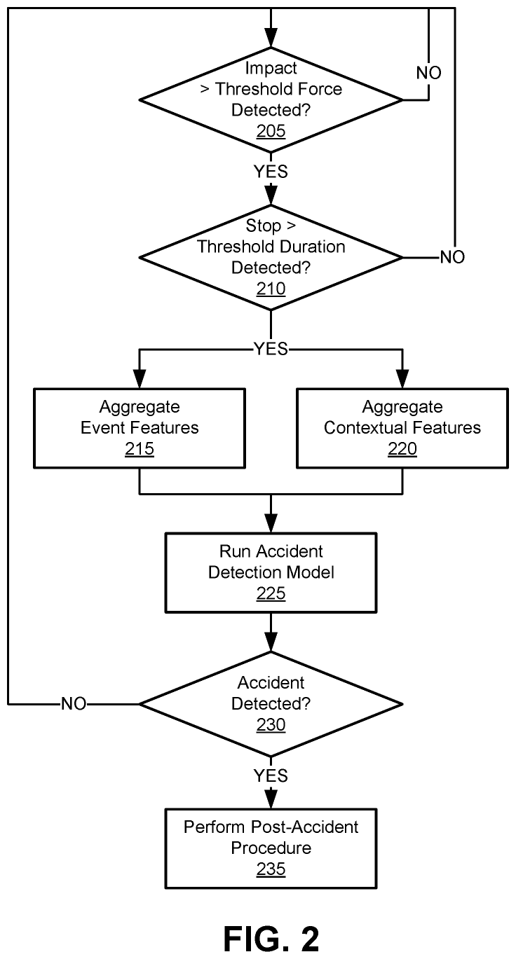

FIG. 2 illustrates a process of determining whether an accident has occurred using a machine-learned model, according to one embodiment. The process uses a machine-learned model that receives inputs including sensor data, event features, and contextual features to determine whether or not an accident has occurred. The process can be performed by any or all of the rider app 115, the driver app 135, the accident modeling subsystem 160, or it can be performed by a combination of these elements. For convenience, the steps will be described from the perspective of the driver app 135, but it should be understood that any or all steps may be performed by the rider app 115 or the accident modeling subsystem 160.

The driver app 135 determines 205 whether an impact detected by the IMU 125 exceeds a threshold amount of force. For example, the driver app 135 may determine whether the IMU 125 detected a specific force greater than a threshold of 3g (where g is the gravitational force). The threshold may be learned by the accident modeling subsystem 160. For example, the accident modeling subsystem 160 can determine a specific force that all or most (e.g., 99%), devices experienced during accidents. The threshold force may be high enough to filter out events that are not caused by accidents, but as discussed below, the specific force is considered in combination many other factors to make a positive determination of an accident. In other embodiments, one or more additional filters that do not rely on this impact threshold can be used to identify potential accidents (e.g., long stops); in this case, the impact threshold for decision 205 may be higher. In some embodiments, the threshold can vary based on, e.g., driving conditions such as weather, current speed, roadway type, type of vehicle, or other factors.

If the driver app 135 does not detect an impact that exceeds the threshold force, the driver app 135 continues to monitor the output of the IMU 125 for possible accident events. If the driver app 135 does detect an impact that exceeds the threshold force, the driver app 135 next determines 210 whether the driver device 120 has been stopped at a location for at least a threshold duration of time immediately (i.e., within another threshold duration of time) after the detection of the impact. If a high g-force is immediately followed by continued vehicle movement (e.g., movement beyond a certain distance, or movement above a certain speed), this indicates that the impact was not the result of an accident. On the other hand, when a high g-force is immediately followed by a stop event (indicating that the vehicle stopped moving), this indicates that the impact may have been the result of an accident. The driver app 135 may identify a stop event based on data from the GPS unit 130 and/or the IMU 125. The rules for determining a stop event can be determined by the accident modeling subsystem 160 based on stop events that all, or nearly all, devices experienced after accidents. The rules for determining a stop event may also vary based on, e.g., driving conditions such as weather, current speed, roadway type, type of vehicle, or other factors.

In some embodiments, the driver app 135 may monitor the IMU 125 and the GPS unit 130 for impact events and stop events simultaneously. In such embodiments, if the driver app 135 does not detect an impact event at 205 but does detect a stop event greater than a threshold duration at 210, the process may proceed to the aggregating steps 215 and 220 (described below). The threshold duration for detecting a stop event be the same duration used for detecting an impact event+stop event, or a different threshold duration may be used; for example, a stop event alone may have a longer threshold duration than if an impact event was also detected. In such embodiments, the process has two triggers for continuing the process to run the accident detection model: either an impact followed by a stop event, or simply a stop event. In other embodiments, alternative or additional types of triggers may be used.

In the example shown in FIG. 2, if the driver app 135 does not detect a stop event, the driver app 135 returns to monitoring the output of the IMU 125 for possible accident events. If the driver app 135 did detect a stop event (or some other trigger for continuing with the process), the driver app 135 aggregates 215 event features and aggregates 220 contextual features. These aggregations may be performed serially or in parallel (as shown in FIG. 2).

Event features are features that describe the impact and/or stop event. Event features may be generated based on data output by one or more sensors of the mobile device or they may represent data coming from another device or mix of different devices, for example, the rider's phone, the driver's phone, sensors on the vehicle itself, sensors on other surrounding vehicles and infrastructure, and so on. The event features can include, for example, specific force of the impact as measured by the IMU 125, distance traveled since the detected impact as measured by the IMU 125 and/or GPS unit 130, time since the detected impact, maximum speed during a time period before the detected impact (e.g., during the 30 seconds before the impact), maximum speed after the detected impact, maximum deceleration in a time period before the detected impact (e.g., during the 30 seconds before the impact), etc.

Contextual features are features about the context of the impact or the ride that may be predictive of whether a detected impact was the result of an accident. For example, contextual features include the distance between the location of the driver device 120 when the impact was detected (referred to as the “impact location”) and the rider's destination, the distance between the impact location and the location at which the rider was picked up by the driver, the driver's active driving time over a time period (e.g., the past 24 hours), the difference between the estimated time of arrival and the time of the impact, the number of stops of at least a threshold duration during the ride, etc. Contextual features can also include features about the location of the driver device 120, e.g., type of roadway, speed limit of roadway, points of interest within a given radius of the location of the driver device 120 (e.g., 100 meters), frequency of prior accidents near the location of the driver device 120, etc. Example of types of roadways include highways, expressways, streets, alleys, country side roads, private driveways, and so on. Contextual features can further include real-time data about the location of the driver device 120, e.g., real-time traffic data, other accidents or events detected in the area, weather conditions at the time of impact, etc. The contextual features can be received from the service coordination system 150, third party data providers, or other sources or combination of sources. For example, weather condition at the time of impact may be obtained from a web service providing weather information, real-time traffic data may be obtained from a service providing traffic data, and so on.

The aggregated event features and contextual features are provided to the accident detection model. The driver app 135 runs 225 the accident detection model, which outputs a value that indicates whether or not an accident is detected. The accident detection model may be a binary classification model that classifies an event as either an accident event or a non-accident event based on the event features and contextual features. Alternatively, the accident detection model may determine a probability that the set of event and contextual features indicates an accident has occurred. In this embodiment, the driver app 135 compares the probability to a threshold probability (e.g., 90% or 95%) to determine 230 whether or not it has detected an accident.

In some embodiments, the distance between the impact location and the destination location is a particularly useful contextual feature. In prior methods for detecting automobile accidents based on sensor data alone, the impact location and destination location were not known to the detection system, so this information could not be used to determine whether an accident occurred. In the system shown in FIG. 1, the rider provides a destination address through the rider app 115, or the driver entered the destination address through the driver app 135. In addition, the driver device 120 includes a GPS unit 130, which enables the driver app 135 to determine the current location of the driver device 120. Based on these two locations, the driver app 135 can determine a distance between the impact location and the destination location.

The distance between the impact location and the destination location is a strong signal in the accident detection model. If the distance is small enough to indicate that the driver has reached the destination location (e.g., the impact location is on the same block as the destination location, or the impact location is less than 100 feet from the destination location), this suggests that the stop detected at 210 is likely caused by the driver dropping off the rider. On the other hand, if the distance is large enough to indicate that the driver has not yet reached the destination location (e.g., the impact location is more than a block from the destination location, or the impact location is greater than 100 feet from the destination location), this indicates a higher likelihood that the stop detected at step 210 was caused by an accident.

If the driver app 135 has not detected an accident, the driver app 135 returns to monitoring the output of the IMU 125 for possible accident events. If the driver app 135 has detected an accident, the driver app 135 performs 235 a post-accident procedure. For example, the post-accident procedure can involve sending a message to a user, for example, for notifying the service coordination system 150 of the accident, notifying local authorities of the accident, notifying an emergency contact about the accident, sending a message to the rider or the driver, or transmitting other notifications. In some embodiments, the driver app 135 transmits data about the event to the service coordination system 150. The data may include some or all of the aggregated event features, the aggregated contextual features, additional contextual data, data obtained from a camera and/or microphone of the driver device 120, data obtained from the driver, etc. The service coordination system 150 may confirm whether an accident has occurred based on the received data. For example, the service coordination system 150 may run an additional accident detection model, have a person review the data received from the driver device 120, request data from cameras in the local area, obtain real time traffic data, and/or request other types of information (e.g., from other riders and/or drivers in the vicinity, from local authorities, etc.) to confirm the accident. In some embodiments, the service coordination system 150 matches the rider to a new driver to complete the rider's ride to the destination.

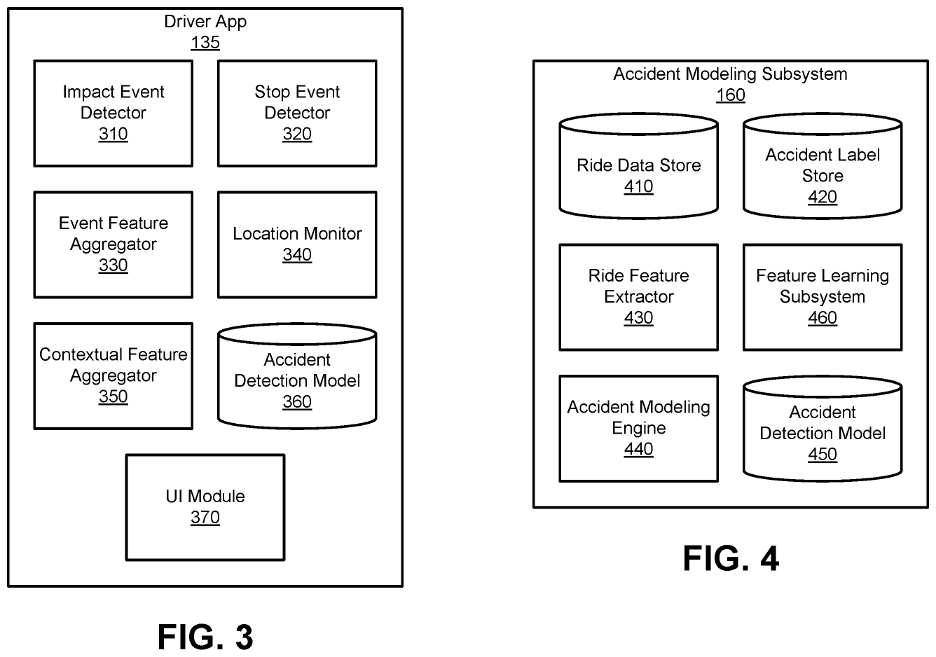

FIG. 3 illustrates a block diagram of the driver app 135, according to one embodiment. The driver app 135 includes an impact event detector 310, a stop event detector 320, an event feature aggregator 330, a location monitor 340, a contextual feature aggregator 350, an accident detection model 360, a UI module 370, and a communications module 380. In other embodiments, the driver app 135 may include additional, fewer, or alternative elements.

The impact event detector 310 receives signals from the IMU 125. The impact event detector 310 compares the acceleration measured by the IMU 125 to a threshold to determine whether a possible impact event has occurred, as described with respect to FIG. 2.

The stop event detector 320 receives location information from the GPS unit 130 and/or the IMU 125 to detect stop events. The stop event detector 320 determines the location of the driver device 120 at the time of the impact event based on a signal received from the GPS unit 130. The stop event detector 320 continues monitoring the location of the driver device 120 based on signals received from the GPS unit 130 to determine if the driver device 120 remains stationary or relatively stationary (e.g., does not move beyond a given range, such as 50 feet, of the impact location during a given period of time after the impact, such as 1 minute). The stop event detector 320 may also monitor the type of movement of the driver device 120 based on signals from the GPS unit 130 and/or the IMU 125. For example, if the movement data indicates that the driver device 120 is moving irregularly at a slow pace, this may indicate that the driver has gotten out of the car and is moving around (e.g., to receive assistance). Alternatively, if the movement data indicates that the driver device 120 is moving in a more linear fashion at a faster pace, this may indicate that the driver has continued driving. As another example, the movement data may indicate that the driver device 120 is in an ambulance, e.g., based on the driving behavior and/or a change in the route.

The event feature aggregator 330 aggregates features describing the event. The event feature aggregator 330 receives data from the IMU 125 and GPS unit 130, or from a data store that stores data from the IMU 125 and GPS unit 130. For example, the event feature aggregator 330 may receive and temporarily store data from the IMU 125 and GPS unit 130 that may be used as event features for the accident detection model 360 if impact and/or stop events are detected, such as speed measurements (e.g., a measured speed at one-second intervals over the past two minutes), acceleration measurements (e.g., measured acceleration at one-second intervals over the past two minutes), location measurements (e.g., location at five-second intervals over the past ten minutes), etc. In other embodiments, the driver app 135 stores speed, acceleration, location, and other types of measurements over the course of the ride, and the event feature aggregator 330 retrieves event data that is used as inputs to the accident detection model 360.

The event feature aggregator 330 may perform statistical analysis of raw data, e.g., determining a maximum speed and acceleration over the last 30 seconds before the impact event, determining an average speed over the past 30 seconds, etc. The event feature aggregator 330 may scale or otherwise adjust the measurements into a format that can be input into the accident detection model 360. For example, the maximum speed over the past 30 seconds can be scaled to a value between 0 and 1, where 0 represents 0 mph and 1 represents 100 mph.

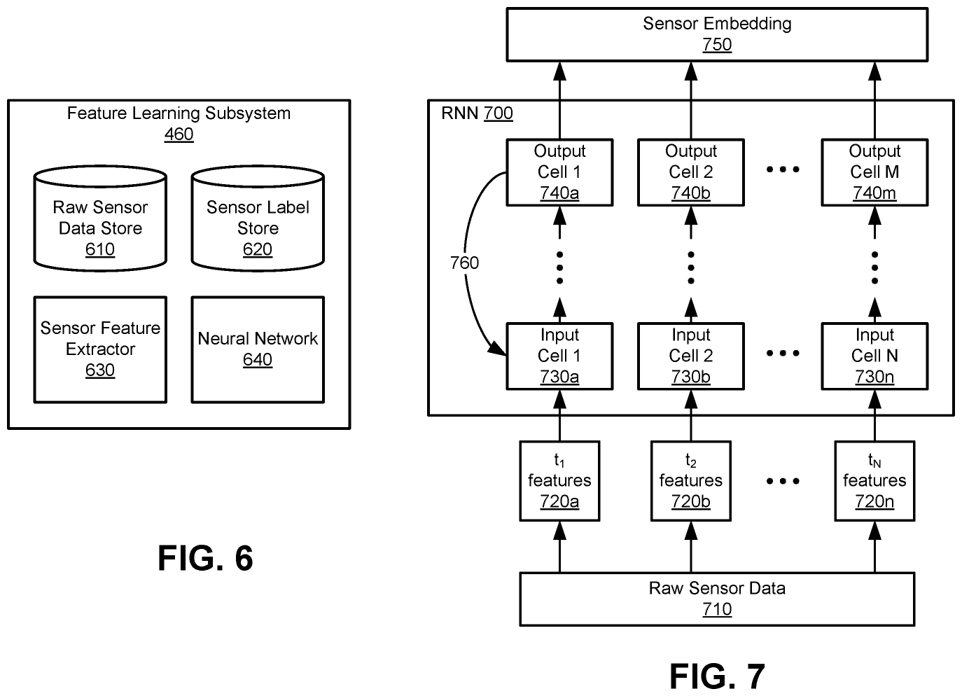

In some embodiments, the event feature aggregator 330 generates a sensor embedding that summarizes features captured from one or more sensors. For example, the feature aggregator 330 may include a trained neural network for generating a sensor embedding based on a sequence of data recorded from one or more sensors during a time window around the impact event. A sensor embedding is a feature vector representation of an input data set that is based on data captured by the one or more sensors. Generating a sensor embedding using a neural network is described in greater detail with respect to FIGS. 6 and 7.

The location monitor 340 tracks the location of the driver device 120 based on the location determined by the GPS unit 130. The location monitor 340 also obtains data relating to the current location of the driver device 120. For example, the location monitor 340 monitors real-time traffic data (e.g., from the communications module 165 or a third-party service) in the area of the driver device 120. The location monitor 340 may compare the location of the driver device 120 to a map with data on roadway features and points of interest, and obtain information about the roadway, information about nearby buildings, information about nearby roadway infrastructure (e.g., exits, bridges, bike paths), etc. from the map data. The location monitor 340 may compare the location of the driver device 120 to the destination address provided by the rider. The location monitor 340 may obtain data about the weather, e.g., from a weather service or another source.

The contextual feature aggregator 350 aggregates features describing the context of the ride and the event. For example, the contextual feature aggregator 350 receives the location data from the location monitor 340 and formats the data for the accident detection model 360. For example, some location data may be converted into binary values, e.g., raining or not raining, gas station in the vicinity or not. Other location data is converted into a value between 0 and 1, such as a value reflecting distance from the destination address, where 0 is the destination address, 0.5 is 50 meters away, and 1 is 100 meters away. The contextual feature aggregator 350 similarly obtains other contextual data used by the model (e.g., records of the speed or location of the driver device 120 over the past 24 hours) and formats it for the accident detection model 360 (e.g., a percentage of time the driver has been driving over the past 24 hours). In some embodiments, the contextual feature aggregator 350 also interfaces with one more devices within or coupled to the driver's vehicle. For example, the contextual feature aggregator 350 may receive data from the vehicle itself, a tracking device attached to the car, and/or the rider device 100 and generate inputs to the accident detection model 360 based on this received data. Additional data can include barometric pressure sensor data to detect airbag deployment, airbag release information from the vehicle monitoring system, speed or acceleration data recorded by the vehicle, etc.

The accident detection model 360 receives the data input by the event feature aggregator 330 and the contextual feature aggregator 350 and determines a value indicating whether or not the data indicates that an accident has occurred. The accident detection model may be a machine-learned model, such as a neural network, decision tree (e.g., random forest), or boosted decision tree (e.g., using XGBoost). The accident detection model 360 may be a binary classification model for outputting a classification of an event as an accident event or non-accident event. Alternatively, the accident detection model 360 may provide a probability that the input data indicates that an accident has occurred.

The UI module 370 provides a user interface (UI) to the driver. The UI module 370 generates a UI that provides standard ride service interface features, such as information about the rider, the pickup location, the destination information, routing information, traffic information, ETA, etc. The UI module 370 may also provide interface features in the event that an accident is detected. For example, in response to the accident detection model 360 detecting an accident, the UI module 370 may ask the driver if assistance is desired, e.g., if the driver would like to be connected to local emergency services. The UI module 370 may also assist the driver in reporting details of the accident, e.g., by requesting information about accident conditions and photographic evidence that can be submitted to an insurance company.

The rider app 115 can incorporate some or all of the features of the driver app 135. The rider app 115 may have access to less historical information about the driver (e.g., driving history over the past 24 hours) than the driver app 135, but it can include slightly modified event and contextual feature aggregators 330 and 350 and a slightly modified version of the accident detection model 360 based on the information available to the driver app 135. The rider app 115 also has a different UI module. The rider app's UI module provides standard rider interface features (e.g., ability to request a ride, enter a pickup location, and enter a destination location). The rider app's UI module may also provide different features in response to detecting an accident, such as a feature to request to be matched to a new driver, or an alert that another driver is on the way to pick up the rider from the location of the accident.

FIG. 4 illustrates a block diagram of an accident modeling subsystem 160 of the service coordination system 150, according to one embodiment. The accident modeling subsystem 160 creates a machine-learned model (e.g., the accident detection model 360) that can be used by the rider app 115, the driver app 135, and/or the accident modeling subsystem 160 to determine whether a vehicle has had an accident. The accident modeling subsystem 160 includes a ride data store 410, an accident label store 420, a ride feature extractor 430, an accident modeling engine 440, an accident detection model 450, and a feature learning subsystem 460.

The ride data store 410 stores data from prior rides provided by driver devices and/or rider devices. For example, the ride data store 410 stores data describing location, speed, and acceleration of driver devices collected during a set of rides. The ride data store 410 may also include any or all of the contextual features of the rides or drivers described above. The stored ride data is associated with information that can be used to identify the ride, e.g., a ride identifier, date and time, driver identifier, rider identifier, etc. Driver devices may transmit ride data to the service coordination system 150 in real or near-real time, or driver devices may locally store ride data and upload their stored data to the service coordination system 150 at periodic intervals or under certain conditions, e.g., when the driver devices connect to Wi-Fi. Rider devices may provide or upload similar data, collected by the rider devices.

The accident modeling subsystem 160 also includes an accident label store 420 that stores data indicating for which rides accidents occurred. The rides with accidents are identified by, for example, ride identifier, date and time, driver identifier, rider identifier, etc., so that the rides labelled as resulting in accidents can be correlated with rides stored in the ride data store 410. The accident labels can be based on data received from drivers and/or riders reporting accidents, data received from one or more insurance companies regarding accident claims, data from public authorities, and/or one or more other data sources.

The ride feature extractor 430 extracts features from the ride data store 410 and the accident label store 420 that can be used as the basis for the accident detection model 450. For example, the ride feature extractor 430 can extract and format, as needed, the event features and contextual features described with respect to FIGS. 2 and 3. The ride feature extractor 430 may extract features for a subset of the rides in the ride data store 410 based on instructions provided by the accident modeling engine 440.

In some embodiments, the accident modeling subsystem 160 includes a feature learning subsystem 460 that learns features in sensor data for use in detecting accidents. The feature learning subsystem 460 may learn to calculate features based on sensor data obtained from one or more of the IMU 105, the GPS 110, or other sensors. For example, the feature learning subsystem 460 may train a neural network to generate a sensor embedding based on sensor data. The sensor embedding summarizes the sensor information that is relevant to detecting accidents. The feature learning subsystem 460 is described in greater detail with respect to FIGS. 6 and 7.

The accident modeling engine 440 performs machine learning on the data extracted by the ride feature extractor 430 and the labels in the accident label store 420 to train the accident detection model 450. The accident modeling engine 440 selects some or all of the rides identified in the accident label store 420 and obtains the ride features for these rides from the ride feature extractor 430. If the accident modeling subsystem 160 comprises a feature learning subsystem 460, the accident modeling engine 440 also obtains the sensor embeddings for these rides from the feature learning subsystem 460. Rides that had accidents may be considered positive samples. The accident modeling engine 440 also may select a set of negative samples—rides that did not have accidents reported—from the ride data store 410 and instruct the ride feature extractor 430 to extract ride features for the negative samples.

In most cases, a ride stops after an accident. Thus, it can be assumed that for the rides labeled as accidents, the accident event occurred at the end of the ride. The ride feature extractor 430 may identify the point in the recorded ride data at which the driver device stopped moving, or the final point in the ride data at which a high acceleration was detected, and use this as the point of the accident event. In some embodiments, the accident label store 420 may also include a time or geographic location of the accident event that can be compared to the ride data 410 to identify the point of the accident event. The extracted ride features are determined with respect to the identified accident point (e.g., stopped duration after this point, maximum speed 30 seconds before this point, etc.).

For rides that do not end in accidents, the ride feature extractor 430 selects one or more points within the ride as reference points for the negative sample events. For example, the ride feature extractor 430 selects a random point within each ride to use as a reference for a negative sample event. As another example, the ride feature extractor 430 identifies one or more points within the non-accident rides that may resemble accidents (e.g., points at the beginning of long stops, or points at which a high acceleration was detected) and use these as reference points for negative events. The extracted ride features are determined with respect to the selected reference point (e.g., stopped duration after this point, maximum speed 30 seconds before this point, etc.).

The accident modeling engine 440 performs a machine-learning algorithm on the extracted ride features using both the positive and negative samples. For example, the accident modeling engine 440 may use gradient boosting techniques (e.g., XGBoost), random forest techniques, sequence models (e.g., Conditional Random Fields, Hidden Markov Models), neural network techniques, or other machine learning techniques or combination of techniques. The accident modeling engine 440 may identify some subset of the ride features extracted by the ride feature extractor 430 that are useful for predicting whether or not an accident has occurred, and the relative importance of these features. These identified features are the features aggregated at steps 215 and 220 in FIG. 2, and the features that are aggregated by the event feature aggregator 330 and contextual feature aggregator 350 shown in FIG. 3. The output of the accident modeling engine 440 is the accident detection model 450, which receives as input the identified subset of event features and contextual features and outputs a value (e.g., a binary value or a probability) representing whether or not an event represented by the event features and contextual features indicates that an accident has occurred.

The accident detection model 450 may be similar to the accident detection model 360 included in the driver app 135, described with respect to FIG. 3. In some embodiments, only the accident modeling subsystem 160 runs the accident detection model 450, based on data provided by the driver app 135 and/or the rider app 115. In other embodiments, only the driver app 135 and/or the rider app 115 runs the accident detection model 360, which is provided by the accident modeling subsystem 160. In still other embodiments, both the driver app 135 and the accident modeling subsystem 160 run respective accident detection models 360 and 450 to determine whether an accident has occurred. For example, the accident detection model 450 at the accident modeling subsystem 160 may be a larger or more computationally intensive model than the accident detection model 360 on the driver app 135. In this embodiment, if the driver app 135 detects an accident, the driver app 135 alerts the accident modeling subsystem 160, which runs its own accident detection model 450 to confirm the assessment of the driver app 135.

As another example, the feature learning subsystems 460 with its trained neural network for generating an embedding resides on the service coordination system 150, and is not passed to the driver device 120 or the rider device 100. In this example, if the driver app 135 detects an accident, the driver app 135 alerts the accident modeling subsystem 160, which generates a sensor embedding using the trained neural network and inputs the sensor embedding to the accident detection model 450 to obtain a more accurate determination of whether an accident has occurred.

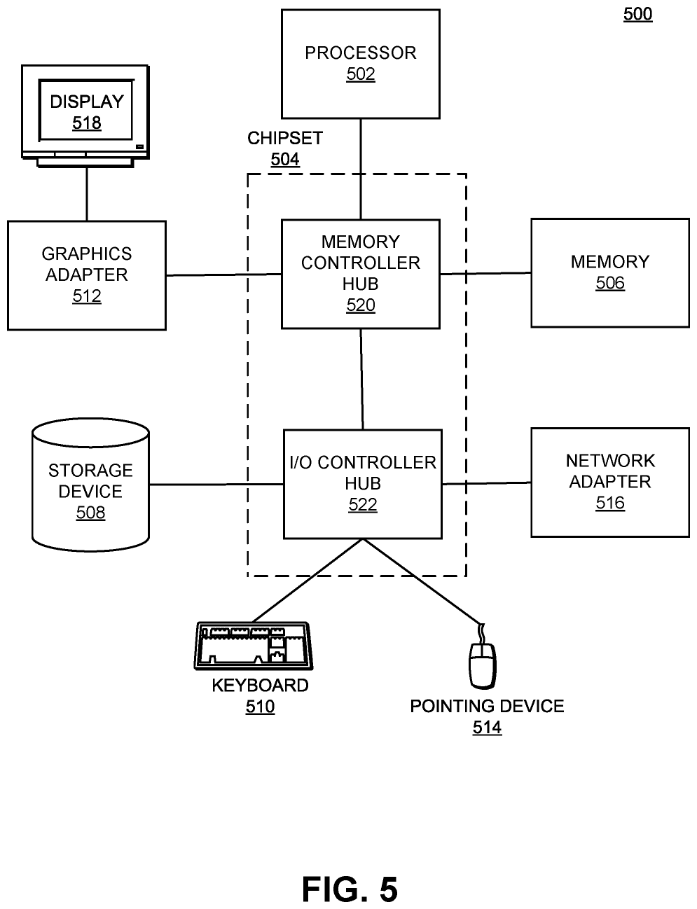

FIG. 5 is a high-level block diagram illustrating an example of a computer suitable for use in the system environment of FIG. 1, according to one embodiment. This example computer 500 can be used as a rider device 100, a driver device 120, or in the service coordination system 150. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CDROM), DVD, or a solid-state memory device. The memory 506 holds instructions and data used by the processor 502. The pointing device 514 is a mouse, track ball, touch-screen, or other type of pointing device, and is used in combination with the keyboard 510 (which may be an onscreen keyboard) to input data into the computer system 500. The graphics adapter 512 displays images and other information on the display 518. The network adapter 516 couples the computer system 500 to one or more computer networks (e.g., network 140).

The types of computers used by the entities of FIG. 1 can vary depending upon the embodiment and the processing power required by the entity. For example, the service coordination system 150 might include a distributed database system comprising multiple blade servers working together to provide the functionality described. Furthermore, the computers can lack some of the components described above, such as keyboards 510, graphics adapters 512, and displays 518.

### Machine Learning Features from Sensor Data

The sensors in the rider device 100 and driver device 120, such as the sensors IMUS 105 and 125 (e.g., accelerometers and gyroscopes), and the GPSes 110 and 130, generate detailed time series data. In some embodiments, the sensors may be outside the devices, for example, sensors of an autonomous vehicle, or sensors installed or located in any type of vehicle. While some sensor readings, like an impact spike detected by the IMU, are recognizable indications of possible accidents, sensor readings also can include more subtle patterns that are indicative of accident events or non-accident events, but that are not recognizable to humans. For example, interactions between multiple sensor readings, such as an accelerometer and a gyroscope, are useful in identifying accidents. However, these sensor readings and data interactions cannot be identified and programmed by a human into the ride feature extractor 430. The feature learning subsystem 460 performs deep learning on time series data received from sensors to automatically engineer features for detecting accidents.

FIG. 6 illustrates a block diagram of the feature learning subsystem 460, according to one embodiment. The feature learning subsystem 460 trains a machine-learned model (e.g., a recurrent neural network) that generates a sensor embedding that summarizes a sequence of time series data generated by one or more sensors, such as the sensors in the IMU 105 or IMU 125. During production, the sensor embedding based on recorded sensor data is input to the accident detection model 360 or 450 for use in determining whether or not a vehicle has had an accident. The feature learning subsystem 460 includes a raw sensor data store 610, a sensor label data store 620, a sensor feature extractor 630, and a neural network 640.

The raw sensor data store 610 stores data for training the neural network 640. The raw sensor data store 610 stores sequences of data from one or more types of sensors for detecting motion in vehicles. For example, the raw sensor data store 610 stores sequences of data, each representing a time series collected by accelerometers and gyroscopes in IMUS, such as IMU 105 and 125, during rides. Each IMU may collect data from multiple accelerometers and gyroscopes, e.g., from three accelerometers for detecting acceleration along an x-axis, a y-axis, and a z-axis. As another example, the raw sensor data store 610 stores data measurements received from or derived from a GPS sensor, such as GPS velocity measurements, or distances traveled between measurements (e.g., distances traveled every 0.1 seconds). Each sensor may record data measurements at a set interval, e.g., every second, every 0.1 second, or every 0.05 seconds, and the raw sensor data store 610 stores the recorded data measurements as a time series.

In some embodiments, the raw sensor data store 610 stores sensor data collected before and during detected stop events and/or drop-off events. For example, if a data intake module of the feature learning subsystem 460 detects a stop event in received sensor data, the feature learning subsystem 460 stores data from the available sensors for a time window around a detected stop event. As another example, if data in the ride data store 410 indicates that a drop-off or a stop event occurred at a particular time for a ride, the feature learning subsystem 460 extracts data from the available sensors stored in the ride data store 410 for a time window around the drop-off, and stores the extracted time window of data in the raw sensor data store 610. Both stop events and drop-off events may include accidents. After an accident, particularly a major accident, the driver typically stops moving for a period of time. More minor accidents can occur during drop-offs but may not lead to long stops, e.g., if the driver taps another car while parking.

The raw sensor data store 610 stores sensor data for a time window around each stop event or drop-off event. For example, the raw sensor data store 610 stores a two-minute window for each available sensor, with one minute before the beginning of the stop event, and one minute after the beginning of the stop event. Other window lengths or configurations may be used. In some embodiments, the stop event detector 320 in a driver app 135 or rider app 115 detects stop events, and transmits sensor data from a time window including the stop event to the service coordination system 150 for storage in the raw sensor data store 610. Similarly, the driver app 135 or rider app 115 may determine that a drop-off occurred, e.g., based on driver input, or based on reaching the destination location, and transmit sensor data from a time window including the drop-off event to the service coordination system 150 for storage in the raw sensor data store 610. In other embodiments, the raw sensor data store 610 stores a subset of the data stored in the ride data store 410. In such embodiments, the feature learning subsystem 460 may identify drop-off and stop events based on data in the ride data store 410, and extracts sensor data from the ride data store 410 for a time window around the identified drop-off and stop events.

The sensor label store 620 stores data indicating which sensor data was collected during stop events or drop-off events that include accidents, and which sensor data was collected during stop events or drop-off events that did not include an accident. The sensor labels are used in conjunction with the data in the raw sensor data store 610 to train the neural network 640. The data in the sensor label store 620 may be extracted from the accident label store 420. The data in the raw sensor data store 610 and in the sensor label store 620 can be associated with a ride identifier or other identifying information, so that the accident labels can be correlated with the sensor data stored in the raw sensor data store 610. As with the data in the accident label store 420, the accident labels in the sensor label store 620 can be based on data received from drivers and/or riders reporting accidents, data received from one or more insurance companies regarding accident claims, data from public authorities, and/or one or more other data sources.

The sensor feature extractor 630 extracts features from sequences of sensor data in a format that can be input into a model, such as the neural network 640. During training of the neural network 640, the sensor feature extractor 630 extracts features from the data sequences stored in the raw sensor data store 610. During production, the sensor feature extractor 630 extracts features from data sequences received from a rider device 100 or driver device 120, and the extracted features are used to determine whether or not an accident has occurred.

The extracted features summarize time series data. In particular, the sensor feature extractor 630 calculates statistics that describe various intervals within a time window of sensor data. For example, for each one-second interval within a time window of sensor data, the sensor feature extractor 630 calculates a minimum, maximum, mean, standard deviation, and fast Fourier transform (FFT) for data points in the time series within the one-second interval. These sets of statistics are arranged as a sequence of features, which are determined by repeatedly evaluating the statistics based on sensor data collected for subsequent time intervals within the portion of the ride. The sensor feature extractor 630 may use different interval lengths, such as 0.5 seconds, 2 seconds, etc. The sensor feature extractor 630 may calculate the same statistics for each type of sensor data (e.g., acceleration, velocity, etc.), or the sensor feature extractor 630 may calculate different statistics for different types of data.

If the raw sensor data includes data from multiple sensors, the sensor feature extractor 630 may concatenate the extracted features from each sensor for each time interval. For example, for a particular time interval, the extracted features include the minimum, maximum, mean, standard deviation, and FFT for each of the accelerometers, each of the gyroscopes, and the GPS velocity. All of the statistics for each time interval are concatenated together in a predetermined order, and the concatenated features are arranged as a sequence of features.

The neural network 640 receives the extracted sequence of features and determines a sensor embedding based on the feature sequence. The neural network 640 is trained based on the data in the raw sensor data store 610 and the sensor label store 620 to determine a sensor embedding that summarizes features relevant to determining whether or not sensor data indicates that an accident has occurred. After the neural network 640 has been trained, the neural network 640 may be provided to the driver app 135 for use in detecting an accident, as described with respect to FIG. 3. The feature extractor 630 may also be provided to extract features at the driver app 135 to input to the neural network 640. In addition or alternatively, the feature extractor 630 and neural network 640 are used by the accident modeling subsystem 160 for use in detecting accidents, as described with respect to FIG. 4.

In the neural network 640, nodes are connected together to form a network. The nodes may be grouped together in various hierarchy levels. The nodes may represent input, intermediate, and output data. A node characteristic may represent data, such as a feature or set of features, and other data processed using the neural network. The node characteristics values may be any values or parameters associated with a node of the neural network. Each node has an input and an output. Each node of the neural network is associated with a set of instructions corresponding to the computation performed by the node. The set of instructions corresponding to the nodes of the neural network may be executed by one or more computer processors. The neural network 640 may also be referred to as a deep neural network.

Each connection between the nodes (e.g., network characteristics) may be represented by a weight (e.g., numerical parameter determined in a training/learning process). In some embodiments, the connection between two nodes is a network characteristic. The weight of the connection may represent the strength of the connection. In some embodiments, a node of one level may only connect to one or more nodes in an adjacent hierarchy grouping level. In some embodiments, network characteristics include the weights of the connection between nodes of the neural network. The network characteristics may be any values or parameters associated with connections of nodes of the neural network.

FIG. 7 shows an example recurrent neural network (RNN) 700 for generating sensor embeddings from sensor data, in accordance with an embodiment. Raw sensor data 710 is transformed into a set of extracted features 720, which are input to the RNN 700. The RNN 700 outputs a sensor embedding 750, which is a feature vector representation of the extracted features 720.

The raw sensor data 710 includes sequences of time series data from one or more sensors. During training of the neural network 700, the raw sensor data 710 is provided by the raw sensor data store 610. During production, the raw sensor data 710 is data received from sensors, e.g., the IMU and GPS, of a mobile device operating in a vehicle.

The extracted features 720 are extracted from the raw sensor data 710 by the sensor feature extractor 620, described with respect to FIG. 6. The sensor feature extractor 620 extracts a set of extracted features for each time interval in the time window of time series data, and the features for each time interval are arranged in a sequence. For example, the t₁ features 720a include the extracted features for the available sensors for a first time interval, the t₂ features 720b include the extracted features for the available sensors for a second time interval, and the t_{N} features 720n include the extracted features for the available sensors for an Nth time interval. The number N of time intervals is based on the length of the interval and the length of the time window. For example, if the time intervals are each 1 second long, and the time window is 1 minute, there are N=120 sets of extracted features 720.

The RNN 700 is an example of the neural network 640. In an RNN, one or more nodes are connected to form a directed cycle or a loop. An example RNN includes one layer, such as the input layer formed of input cells 730, that occurs before another layer, such as the output layer formed of output cells 740, when tracking the layers from the input layer to the output layer. The output of the first layer is provided as input to the second layer, possibly via one or more other layers (not shown in FIG. 7). The RNN is configured to provide as feedback the output of the second layer as input to the first layer (possibly via other layers). For example, as shown in FIG. 7, the output of the output layer formed from output cells 740 is provided as an input 760 to the input layer formed from the output cells 730. The feedback loops of an RNN allow the RNN to store state information. As another example, the RNN 700 may include a layer such that the output of the layer is provided as input to the same layer. The directed cycles allow the recurrent neural network to store state information, thereby acting as internal memory for the RNN 700.

In an embodiment, the RNN 700 is a long short term memory (LSTM) neural network. In an LSTM, each cell remembers values over arbitrary time intervals. Each cell comprises the three gates—an input gate, an output gate, and a forget gate—that regulate the flow of information into and out of the cell. The forget gate controls the extent to which a value remains in the cell, and the output gate controls the extent to which the value in the cell is used to compute the output activation of the LSTM unit.

As shown in FIG. 7, the RNN 700 includes at least two layers, i.e., a layer of input cell 730, and a layer of output cells 740. In some embodiments, the RNN 700 includes additional hidden layers between the input layer and the output layer, not shown in FIG. 7. In other embodiments, the RNN 700 includes only two layers, i.e., the input layer and the output layer. Each input cell 730 receives a set of features 720. For example, input cell 1 730a receives the t₁ features 720a, and input cell N receives the t_{N} features 720n. In this embodiment, the number of input cells 730 matches the number of sets of features 720. In other embodiments, the number of input cells 730 is different from the number of sets of features 720. For example, one input cell 730 may receive multiple sets of features, or one set of features may be provided to multiple input cells 730.

Different layers within the RNN 700 can include different numbers of cells or the same number of cells. For example, as shown in FIG. 7, the output layer has M cells, and M may be different from N. The connections between the input cells 730 and the next layer of cells (e.g., the layer of output cells 740) can have any configuration, and the connections and/or weights of the connections can be determined based on training of the RNN 700.

The output of the RNN 700 is the sensor embedding 750 that summarizes the features 720 extracted from the raw sensor data 710. Each layer of the LNN 700 generates embeddings representing the sample input data at various layers, and the outputs of the output cells 740 form the sensor embedding 750. The number M of output cells 740 may correspond to the length of a sensor embedding 750 output by the LNN 700. For example, the sensor embedding 750 is a vector with length 100, and the number M of output cells 740 is 100. During production, the sensor embedding 750 generated based on raw sensor data 710 is provided as an input to the accident detection model 450 and used to determine whether the sensor data and other features indicate that an accident has occurred.

### Additional Considerations

The system determines the likelihood of an event representing an accident based on factors including whether the event occurred in a residential area or a business area. The system may determine whether the location of the event is a residential area of a business area based on a measure of density of points of interest based on a number (or quantity) of points of interest within a unit area. Accordingly, if the location has more than a threshold number or businesses within a unit area. The points of interest may represent businesses such as offices, stores, malls, or attractions. In some embodiments, the system determines whether the location is within a residential area or business area based on map data, for example, annotations in the map. Accordingly, the system accesses a map that annotates various locations with metadata describing the type of location, for example, residential area or business area. A map service may determine a type of area based on factors such as whether the street/area is zoned for residential or commercial use or whether the street has mostly residential lots or commercial buildings.

Although various embodiments are described herein based on machine learning based models, other embodiments can determine scores based on weighted aggregates of feature values. The weights may be determined by any mechanism, for example, configured by a user such as an expert. Alternatively, the system may determine that an accident occurred based on comparison of one or more features with a corresponding threshold value or by comparing a weighted aggregate value of one or more features with a threshold value. The threshold may be specified by a user or determined based on historical data, for example, corresponding score values when accidents occurred in the past and when accidents did not occur in the past.

As an example, if an event representing a potential accident was close to the destination, then the system determines that the likelihood of the event representing an accident is low compared to the event occurring in the middle of the trip or early on in the trip. Alternatively, if an event representing a potential accident was in the middle of the trip or early on in the trip, then the system determines that the likelihood of the event representing an accident is high compared to the event occurring close to the end of the trip. As another example, if the system determines that the event representing a potential accident occurred on a small roadway, the system determines that the likelihood of the event representing an accident is low compared to a similar event that occurs on a busy highway. As another example, if the system determines that the event representing a potential accident occurred next to shops, then the system determines that the event is less likely to be an accident compared to a similar event that occurs in a residential area.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for compressing neural networks. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

We claim:

1. A computer-implemented method for detecting a vehicle accident comprising:
detecting, based on at least a first signal related to an acceleration measurement by a mobile device, an impact event having a specific force greater than a threshold force;
determining, based on at least a second signal related to a location measurement by the mobile device, that the mobile device has been stopped for at least a threshold duration following the impact event;
in response to detecting the impact event and determining that the mobile device has been stopped:
aggregating a plurality of event features describing the impact event, the event features comprising features generated based on data output by a plurality of sensors of the mobile device within at least one threshold time period that includes a time of the impact event;
aggregating a plurality of contextual features describing the context of the impact event, the contextual features comprising features generated based on data describing a ride during which the impact event occurred; and
predicting, using a machine-learned model trained to detect vehicle accidents based on event features and contextual features, that a vehicle accident has occurred based on the plurality of event features and the plurality of contextual features; and
responsive to determining that the vehicle accident has occurred, transmitting a message comprising information describing the vehicle accident.

2. The computer-implemented method of claim 1, wherein the mobile device is located within the vehicle and predicting, using the machine-learned model is performed on a remote system executing on a server outside the vehicle, wherein the mobile device sends information describing the ride to the remote system.

3. The computer-implemented method of claim 1, wherein the machine-learned model is a first machine-learned model, wherein responsive to the first machine-learned model indicating a high likelihood that an accident has occurred, further comprising:
providing information describing the ride to a second machine-learned model for confirming whether an accident has occurred.

4. The computer-implemented method of claim 1, further comprising:
providing sensor data associated with the ride to a neural network to generate a sensor embedding representing features describing the sensor data; and
wherein the machine machine-learned model receives the sensor embedding as input.

5. The computer-implemented method of claim 1, wherein the plurality of event features comprises one or more of:
a measure of force of the impact;
distance traveled since the impact;
a measure of speed during a time period before the impact; and
a measure of deceleration in the time period before the impact.

6. The computer-implemented method of claim 1, wherein the plurality of contextual features comprises one or more of:
a distance between a location of the vehicle at the time of impact and a destination of the ride;
a distance between the location of the vehicle at the time of impact and the location of the starting point of the ride; and
a difference between an estimated time of arrival at the destination and the time of impact.

7. The computer-implemented method of claim 1, wherein the plurality of contextual features comprises one or more of:
a type of a roadway where the impact occurred;
a speed limit of the roadway where the impact occurred;
information describing points of interest within a threshold distance of the location of impact; and
a measure of frequency of accidents within a threshold distance of the location of impact.

8. The computer-implemented method of claim 1, wherein the plurality of contextual features comprises one or more of:
information describing weather at the time of impact;
information describing traffic within a threshold distance of the location of the impact;
a speed limit of the roadway where the impact occurred; and
information describing one or more events within a threshold distance of the location of impact.

9. The computer-implemented method of claim 1, further comprising:
training the machine-learned model using a training dataset determined using information describing previous rides, the training dataset comprising:
one or more positive samples, each positive sample representing a ride with an accident; and
one or more negative samples, each negative sample representing a ride without an accident.

10. A computer-implemented method for detecting a vehicle accident comprising:
receiving a plurality of sequences of data collected by a plurality of sensors during a ride, wherein each sequence of data represents a time series describing a portion of the ride comprising one of a stop event or a drop-off event;
generating a sequence of features from the plurality of sequences of data, the sequence of features determined by repeatedly evaluating one or more statistics based on sensor data collected within the portion of the ride;
providing the sequence of features as input to a neural network, the neural network comprising one or more hidden layers of nodes;
extracting a sensor embedding representing output of a hidden layer of the neural network, wherein the sensor embedding is generated by the hidden layer responsive to providing the sequence of features as input to the neural network;
determining, using a machine-learned model trained to detect vehicle accidents based on a sensor embedding, that a vehicle accident has occurred based on the extracted sensor embedding; and
responsive to determining that the vehicle accident has occurred, transmitting a message comprising information describing the vehicle accident.

11. The computer-implemented method of claim 10, wherein the neural network is a recurrent neural network.

12. The computer-implemented method of claim 10, wherein the neural network is a long short term memory (LSTM) neural network.

13. The computer-implemented method of claim 10, wherein the plurality of sensors comprises one or more of: an accelerometer, a gyroscope, or a global positioning system receiver.

14. The computer-implemented method of claim 10, wherein receiving a sequence of data comprises:
detecting an event indicating one of: a stop event indicating that the vehicle stopped or a drop-off event; and
receiving data from one or more sensors for a time window around the detected event.

15. The computer-implemented method of claim 10, wherein extracting features from the plurality of sequences of data comprises:
determining a fast Fourier transform for data points of the time series with a time interval.

16. The computer-implemented method of claim 10, further comprising:
training the neural network model using previously recorded training dataset describing rides, the training dataset comprising data describing one or more rides labeled as having an accident based on an accident report.

17. A non-transitory computer readable storage medium storing instructions that when executed by a computer processor, cause the computer processor to perform the steps comprising:
detecting, based on at least a first signal related to an acceleration measurement by a mobile device, an impact event having a specific force greater than a threshold force;
determining, based on at least a second signal related to a location measurement by the mobile device, that the mobile device has been stopped for at least a threshold duration following the impact event;
in response to detecting the impact event and determining that the mobile device has been stopped:
aggregating a plurality of event features describing the impact event, the event features comprising features generated based on data output by a plurality of sensors of the mobile device within at least one threshold time period that includes a time of the impact event;
aggregating a plurality of contextual features describing the context of the impact event, the contextual features comprising features generated based on data describing a ride during which the impact event occurred; and
predicting, using a machine-learned model trained to detect vehicle accidents based on event features and contextual features, that a vehicle accident has occurred based on the plurality of event features and the plurality of contextual features; and
responsive to determining that the vehicle accident has occurred, transmitting a message comprising information describing the vehicle accident.

18. The non-transitory computer readable storage medium of claim 17, wherein the machine-learned model is a first machine-learned model, wherein responsive to the first machine-learned model indicating a high likelihood that an accident has occurred, wherein the instructions further cause the computer processor to perform steps comprising:
providing information describing the ride to a second machine-learned model for confirming whether an accident has occurred.

19. The non-transitory computer readable storage medium of claim 17, wherein the instructions further cause the computer processor to perform steps comprising:
providing sensor data associated with the ride to a neural network to generate a sensor embedding representing features describing the sensor data; and
wherein the machine machine-learned model receives the sensor embedding as input.

20. The non-transitory computer readable storage medium of claim 17, wherein the instructions further cause the computer processor to perform steps comprising:
training the machine-learned model using a training dataset determined using information describing previous rides, the training dataset comprising:
one or more positive samples, each positive sample representing a ride with an accident; and
one or more negative samples, each negative sample representing a ride without an accident.
